(19) United States
(12) Patent Application Publication
(10) Pub. No.: US 2026/0100524 A1
(43) Pub. Date: Apr. 9, 2026

(54) HIGH-CURRENT CONNECTION SYSTEM

(71) Applicant: ERWIN QUARDER SYSTEMTECHNIK GMBH, Espelkamp (DE)

(72) Inventors: Thomas PENNER, Espelkamp (DE); Johann WIENS, Espelkamp (DE)

(73) Assignee: ERWIN QUARDER SYSTEMTECHNIK GMBH, Espelkamp (DE)

(21) Appl. No.: 19/415,890

(22) Filed: Dec. 11, 2025

Related U.S. Application Data
(63) Continuation of application No. PCT/EP2024/066914, filed on Jun. 18, 2024.

(30) Foreign Application Priority Data
Jun. 19, 2023 (DE) 102023115973.9

(51) Int. Cl. H01R 4/44; H01R 13/621

(52) U.S. Cl. CPC H01R 4/44; H01R 13/6215

(57) ABSTRACT

A high-current connection system includes a high-current-conducting bridging part which can be fastened to each of two high-current busbars and by which the distance between the high-current busbars can be current-conductively bridged and with which at least two spaced-apart spherically inwardly domed connection faces are associated, for each high-current busbar, a high-current-conducting compensation element which can be disposed between the bridging part and the associated high-current busbar and which has a spherically outwardly domed compensation face which, when the bridging part is in the fastened state, faces one of the spherically inwardly domed connection faces, and is electrically connected thereto, and for each high-current busbar, at least one fastening element which can be associated with the high-current busbar, and by means of which the bridging part and the associated compensation element can be fastened to the associated high-current busbar and secured against movement relative to the associated high-current busbar.

### CROSS-REFERENCE TO RELATED APPLICATIONS

This patent application is a continuation of, and as such claims priority to, International Patent Application No. PCT/EP2024/066914, filed on Jun. 18, 2024, which claims priority to and all advantages of German Patent Application No. DE 10 2023 115 973.9, filed on Jun. 19, 2023; each of the foregoing applications are incorporated herein by reference in their entireties.

### BACKGROUND

Especially for battery-powered vehicles (but also for other applications), high-current busbars, also called busbars, made of conductive materials such as copper, are used to transmit the high currents required to operate such vehicles from the energy source, i.e., the battery pack, to the consumers (electric motor, etc.). These high-current busbars therefore have comparatively large cross-sectional areas.

When high-current busbars are spaced apart, it may be necessary to connect them at specific contact points using high-current conductive methods. For this purpose, lamellar connectors are known, which must be screwed to the ends of the busbars to be joined.

Depending on local or other circumstances, it may happen that the individual components of known high-current connection systems—for example, due to tolerances—cannot be connected to the high-current rails, or not optimally, so that no electrical connection or an optimal electrical connection can be established.

US 2017/0352964 A1 discloses a connector device for electrically connecting the poles of two adjacent battery cells, comprising an electrically conductive busbar with a first connection area and a second connection area spaced apart from the first, an electrically conductive pole engagement component, and fastening components for attaching the electrically conductive busbar and the pole engagement components to one of the poles of the two adjacent battery cells.

### SUMMARY

The present disclosure relates to a high-current connection system with which at least two spaced-apart high-current rails can be connected to each other in a high-current conductive manner, a compensating element, a bridging part and an arrangement comprising the high-current connection system and at least two high-current rails.

For the purposes of this application, components suitable for high current applications are defined as those capable of conducting currents of at least 40 amperes, such as at least 400 amperes.

The object of the present disclosure is to further develop the aforementioned high-current connection system. In particular, it is an object of the disclosure to provide a high-current connection system that is convenient and easy to install. Specifically, it is an object of the disclosure to provide a high-current connection system that enables a reliable electrical connection.

This problem is solved by a high-current connection system for the high-current conductive connection of at least two spaced-apart high-current rails, comprising:
A high-current conductive bridging element, attachable to each of the high-current rails, with which the distance between the high-current rails can be bridged in a conductive manner and to which at least two spaced-apart, spherically inwardly curved connecting surfaces are assigned,
For each high-current rail, one corresponding, high-current conductive compensating element is required, which can be arranged between the bridging part and the respective high-current rail and which has a spherically outwardly curved compensating surface that, in the fixed state of the bridging part, faces one of the spherically inwardly curved connecting surfaces and is electrically conductively connected to it.
For each high-current rail, at least one corresponding fastening means is required, with which the bridging part and the respective compensating element can be attached to the respective high-current rail and secured against movements relative to the respective high-current rail, and wherein
the bridging element is designed in a wave-like shape in a longitudinal section, and that in the fixed state of the bridging element a wave trough of the bridging element is arranged between the high-current rails, and/or that in the fixed state of the bridging element each of the connecting surfaces assigned to the bridging element is arranged in the area of a wave crest of the bridging element.

Furthermore, the problem is solved by means of a bridging part of the high-current connection system, wherein the bridging part is designed to be high-current conductive, can be attached to each of the high-current rails, is designed to bridge the distance between the high-current rails in a current-conducting manner and has at least two spaced-apart, spherically curved inwards connecting surfaces, and the bridging element is designed in a wave-like shape in a longitudinal section, and that in the fixed state of the bridging element a wave trough of the bridging element is arranged between the high-current rails, and/or that in the fixed state of the bridging element each of the connecting surfaces assigned to the bridging element is arranged in the area of a wave crest of the bridging element.

Furthermore, this problem is solved by means of an arrangement of at least two high-current rails and a high-current connection system, wherein the two high-current rails are connected to each other in a high-current conductive manner with the high-current connection system.

The high-current connection system may comprise a detachable connection of at least two spaced-apart high-current rails, wherein the fastening means for each high-current rail is designed such that the bridging part and the respective compensating element can be detachably fastened to the respective high-current rail and secured against movements relative to the respective high-current rail.

In the use of the high-current connection system, the bridging part may be connected to each of the two high-current rails in a high-current conductive manner, for example in the area of two opposite ends of the bridging part, for example in a corresponding contact area of the respective high-current rail.

The bridging element may be detachably attached to or connected to the respective high-current rail in the contact areas using a compensating element and a fastening element, so that even in installation situations where the position of the high-current rails is already fixed and only a limited installation space is available, subsequent installation of the high-current connection system is possible. This also makes it easy to replace individual components of the high-current connection system in case of wear.

In order to adapt the high-current connection system to any installation tolerances and/or any component tolerances, etc., the compensating elements each have a spherically curved compensating surface, and the bridging part is correspondingly assigned spherically curved connecting surfaces.

The high-current rails can then be connected to each other via the electrically conductive bridging element and the respective(s) electrically conductive compensating elements when the bridging element is in its fixed position, allowing electrical current to flow through these components from one high-current rail to the other. In the simplest case, each (metallic) compensating element can be made directly electrically conductive against the respective contact area of its associated high-current rail, as well as directly electrically conductive against the respective connecting surface, which is made of the same material as the bridging element. Naturally, it is also conceivable to use electrically conductive connecting pastes, etc., as intermediate layers. In an example, connecting pastes are arranged between each pair of adjacent components. The connecting pastes comprise pastes, lubricants, or other known substances that are electrically conductive and suitable as an intermediate layer between two adjacent, high-current conductive components. Connecting pastes may be used between the compensating element and the bridging element, for example, between its compensating surface and connecting surface. It is also conceivable to use bonding pastes between other two adjacent components, such as a washer and the bridging part.

The respective compensating surface and the respective connecting surface may each form a hinged connection (with corresponding degrees of freedom) similar to a ball joint. A hinged connection, as defined in the present application, provides a movable connection between two components arranged in the annex. The bridging element and the compensating element may be arranged in the annex. The bridging element and the compensating element may be designed such that a movable connection is provided between the bridging element and the compensating element. For example, the compensating surface of the respective compensating element and the respective connecting surface of the bridging element may be designed such that a movable connection is provided between the connecting surface of the bridging element and the compensating surface of the compensating element.

In the simplest case, the connecting surfaces can be an integral part of the bridging component, made entirely of the same material. They can be molded into the bridging component, for example, if the bridging component is a casting, or incorporated into it through suitable material processing. Theoretically, it is also conceivable that the bridging component has additional connecting elements, which could be welded or brazed to it, and which then provide the connecting surfaces. As the expert will recognize, a wide variety of possibilities exist.

Each compensating element can have a central through-hole, in particular an elongated hole, which, relative to or in the fastened state of the bridging element, is penetrated by one of the fastening means, in particular an elongated one. The use of such an elongated hole allows for adjustment of the respective position of the compensating elements relative to the respective high-current rail or its respective contact area.

Furthermore, the compensating elements can have a flat side on their side opposite the compensating surface, which, in the fixed state of the bridging part, then faces the respective high-current rail, in particular—in the simplest case—under electrically conductive connection to the respective high-current rail, possibly using an electrically conductive intermediate layer or intermediate layer.

For a similar purpose, the bridging part can also have at least two through holes, in particular each designed as an elongated hole, wherein each of these through holes is penetrated by one of the fastening means, in particular elongated ones, when the bridging part is fastened.

In the fixed state of the bridging element, each through-hole of the bridging element can be aligned with a through-hole of one of the compensating elements along a common axis (one above the other), and the respective fastening element can pass through both through-holes in this state. For example, a through-hole of the bridging element may be aligned with the through-hole of a compensating element so that the respective fastening element can pass through both through-holes.

In an example, the high-current connection system comprises at least one fastening element for each high-current rail, with which the bridging element and the respective compensating element can be detachably fastened to the respective high-current rail. It can be provided that the respective fastening element, in particular a screw, when the bridging element is fastened, extends into or through a through-hole in the respective high-current rail and is connected to a suitable locking element of the high-current connection system, which is supported on the high-current rail and may have a matching thread, by means of a force-fit and/or form-fit connection, in particular by screwing. This may be done with a threaded sleeve or a nut. Alternatively, the respective fastening element, designed as a screw, can also be screwed into a thread introduced into the high-current rail when the bridging element is fastened. Another example of the fastening element is also conceivable, which is suitable for making the bridging element and the compensating element attachable and lockable to the high-current rail.

Regarding the specific design of the bridging element, it can, for example, have a wave-like shape in longitudinal section. For the purposes of this disclosure, the term “wave-like” is defined as follows: the bridging element has a configuration with a first section and a second section, extending over the entire length of the bridging element. The first section is a recurring section with raised sections. The second section is arranged between two successive first sections and connects the first section to further first sections. This connection can be in the form of a depression or a flat surface. Hereinafter, the first section is also referred to as the wave crest, and the second section as the wave trough. In the installed state of the bridging element, a wave trough of the bridging element can be located between the high-current rails, and/or each of the connecting surfaces associated with the bridging element can be located in the region of a wave crest of the bridging element, particularly on the underside of the respective wave crest.

In the fixed state of the bridging part, a head part of the respective fastening element, in particular designed as a screw, can be secured against relative movements relative to the respective high-current rail by means of force-locking and/or form-locking action under tension directly against the bridging part or against a washer arranged between the head part and the bridging part.

It can be provided that the washer has a spherically concave compensating surface on its side facing the bridging element, which faces a spherically concave connecting surface of the bridging element, in particular with a positive-locking, e.g., detachable, connection, and possible in contact with the respective connecting surface. The bridging element and the washer may be designed such that a movable connection between the bridging element and the washer is provided. The compensating surface of the respective washer and the respective connecting surface of the bridging element may be designed such that a movable connection between the connecting surface of the bridging element and the compensating surface of the compensating element is provided.

The high-current connection system can further comprise a retaining element for each compensating element, e.g., designed as a plastic component, which can be attached to it by means of a force-fit and/or form-fit connection. This retaining element allows the respective compensating element to be detachably attached to the bridging element with its outer surface facing the respective connection surface of the bridging element, such as by means of a detachable clamping of the components against each other, particularly for the formation of a pre-assembled assembly. With such a retaining element, the aforementioned components of the high-current connection system, and optionally further components, such as the aforementioned washer(s), can first be pre-assembled to form a unit or pre-assembled assembly and then connected to the respective high-current rail in this pre-assembled state.

Furthermore, the retaining part can have at least one designed locking device for attachment to the respective compensating element, in particular at least one elastic locking arm (e.g., at least two elastic locking arms), which then engages in a suitable mounting recess in the compensating element when attached.

The retaining part may also have a particularly round through-hole into which, when the bridging part is fastened, the head part of the respective fastening device is at least partially immersed.

### BRIEF DESCRIPTION OF THE DRAWINGS

FIG. 1 shows an oblique view of an example of an arrangement consisting of two high-current busbars and a high-current connection system connecting them in an exploded view.

FIG. 2 shows the arrangement from FIG. 1 in a pre-assembled state in exploded view.

FIG. 3 shows the arrangement from FIG. 1 in top view.

FIG. 4 shows a section through the arrangement from FIG. 1 along the section line B-B in FIG. 3.

FIG. 5 shows a section through the arrangement from FIG. 1 along the section line A-A in FIG. 3.

### DETAILED DESCRIPTION

With a high-current connection system 10 shown in the drawings, two spatially spaced high-current busbars 11 are connected to each other in a high-current conductive manner.

The metallic (rigid) high-current busbars 11, made of copper or another electrically conductive metal or metal alloy, are in the present case each end-shaped L-shaped with an end section angled at 90° to the main longitudinal extent of the respective high-current busbar 11, which simultaneously serves as a contact area 12 in which the high-current connection system 10 contacts the high-current busbars 11.

In order to compensate for possible tolerances etc. in the position of the two high-current rails 11 relative to each other and/or dimensional and/or angular tolerances of the high-current rails 11, the high-current connection system 10 is designed in a special way.

For this purpose, it comprises a wave-shaped, solid metallic bridging element 13, which, in this case, is electrically conductively connected to the respective contact area 12 of the respective high-current busbar 11 via contact areas 16 located at opposite ends of the bridging element 13. These contact areas are situated in the region of wave crests 14a and 14b formed therein of the bridging element 13. This electrical connection between the contact areas 12 of the respective high-current busbar 11 and the contact areas 16 of the bridging element 13 is designed to be detachable, so that it could also be established subsequently on high-current busbars 11 that are already permanently installed on site.

In the state of the bridging element 13 being attached to the high-current rails 11, it is fastened to the high-current rails 11 by means of elongated fastening elements 17, which in this case are designed as screws, and secured against relative movement. For this purpose, the fastening elements 17 are screwed into threaded sleeves 18, which are inserted into through holes 11a in the end sections of the high-current rails 11. It is understood that other fastening elements could also be used.

The bridging element 13 does not lie directly against each high-current rail 11, but is supported on a respective special compensating element 19 designed in the manner of a washer, which in turn rests with a flat underside against the respective top side of the respective end section of the respective high-current rail 11.

Each compensating element 19 has a spherically convex compensating surface 20 which, in the fixed state of the bridging part 13, faces the bridging part 13, more precisely its underside facing the end section of the high-current rail 11.

On this underside of the bridging part 13, in the present case in the area of the wave crests 14 a or 14 b, two spaced-apart connecting surfaces 21 or counter surfaces for the compensating surfaces 20 are formed, matching the respective compensating surface 20 or having their dimensions adapted to the respective compensating surface 20, spherically curved inwards.

The compensating surface 20 of each compensating element 19 then rests against one of the two connecting surfaces 21 of the bridging part 13 when the bridging part 13 is fastened, in this case directly, so that a metallic, current-conducting contact is immediately established. Most importantly, however, the respective compensating surface 20 forms a kind of ball joint with the respective counter surface or connecting surface 21, which allows corresponding compensating movements of the high-current connection system 10 during assembly to compensate for tolerances in three spatial directions.

With the side opposite the compensation surface 20 of the respective compensation element 19, which is designed to be flat as already mentioned, the compensation element 19 lies directly against a corresponding contact surface of the contact area 12 of the high-current busbars 11, also forming a corresponding electrically conductive connection.

It is understood that intermediate layers or intermediate layers of electrically conductive material may also be arranged between the opposing surfaces of the respective components.

On the upper side of each wave crest 14 a or 14 b of the bridging part 13, or on the side of the bridging part 13 facing away from the end region of the high-current rails 11, a washer 24 is also visible, which is arranged between a head part 28 (screw head) of the fastening element 17 and the bridging part 13 and whose respective underside is spherically curved inwards or whose underside has a spherically curved inwards compensation surface 22 and which, due to the clamping force of the fastening element 17, rests against the bridging part 13 in a force-fit and/or form-fit manner and under tension.

The compensating surface 22 of each washer 24 faces one of two correspondingly matching, or dimensionally adapted, spherically convex connecting surfaces 23 of the bridging part 13, which are arranged (and spaced apart from each other) on the upper surfaces of the wave crests 14a and 14b, respectively, and are formed by them, and rests against these surfaces in a kind of ball joint. Accordingly, the aforementioned elements or components also allow compensating movements in three spatial directions.

As already indicated, the high-current rails 11 each have a through-hole 11a into which the respective threaded sleeve 18 is inserted from below. Furthermore, the bridging element 13 also has two through-holes 13a (each designed as an elongated hole), the central axes of which are aligned with the central axis of the respective through-hole 11a of the respective high-current rail 11, or are aligned along the same central axis as the respective through-hole 11a.

Along the same axis, a (central) through hole 19 a of the respective compensating element 19 or a (central) through hole 24 a of the respective washer 24 is also aligned, so that the respective fastening element 17 can reach through all of these components or all through holes 11 a, 19 a, 13 a and 24 a from top to bottom and is then screwed into the respective threaded sleeve 18 which is supported on the underside of the respective high-current rail 11.

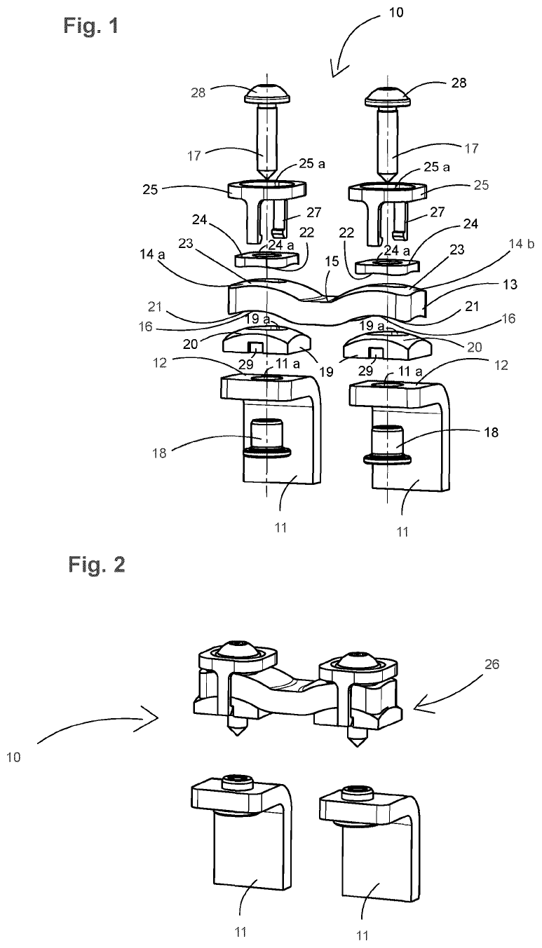

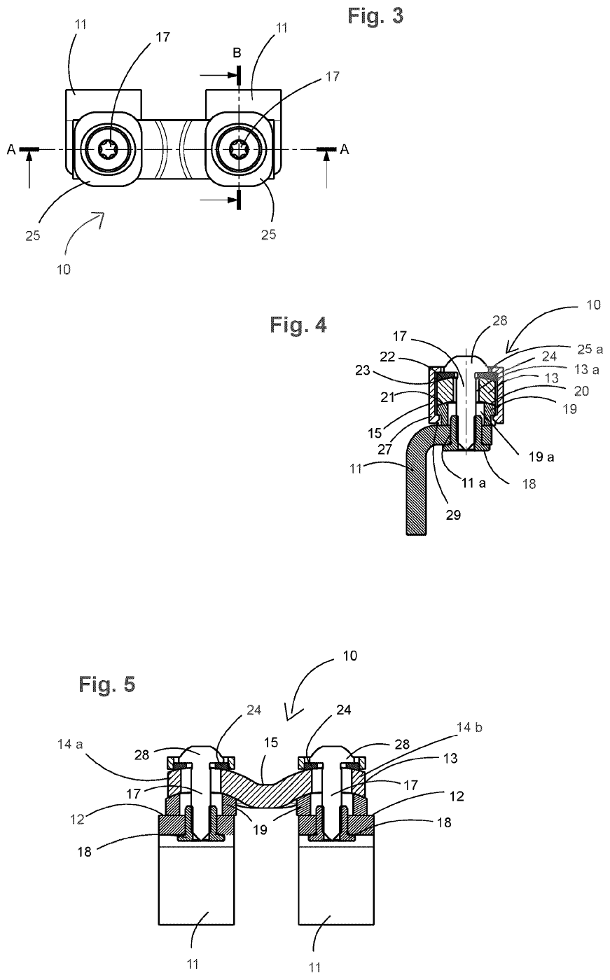

As can be further seen, the high-current connection system 10 has a retaining part 25 for each compensating element 19, which can be attached to it by means of a force-fit and/or form-fit connection, with which the respective compensating element 19 is detachably attached to the bridging part 13 with its outer side facing the respective connection surface of the bridging part 13, such as with detachable clamping of the components against each other, in particular to form a pre-assembly assembly 26 simplifying the final assembly of the high-current connection system 10, cf. FIG. 1, which in the present case comprises, in addition to the bridging part 13, the two compensating elements 19, the two retaining parts 25, the two washers 24 and the two fastening means 17.

Each retaining part 25 has two elastic locking or retaining arms 27 for attachment to the respective compensating element 19, each of which engages in a respective fastening recess 29 of the respective compensating element 19.

The retaining part 25 further has a particularly round through-hole 25 a into which the head part 28 of the respective fastening element 17 is at least partially immersed.

It is understood that the features explained in connection with the drawings are only to be understood as examples and do not limit the subject matter of the present application.

### LIST OF REFERENCE NUMBERS

10 High-current connection system
11 High-current rail
11 a Through hole
12 Contact area high-current rail
13 Bridging part
13 a Through hole
14 a, b Wave crests Bridging section
15 Wave trough bridging section
16 Contact area bridging part
17 Fasteners
18 threaded sleeve
19 compensating elements
19 a Through hole
20 compensation areas
21 Connecting surface Bridging part
22 Compensation surface washer
23 Connecting surface bridging part
24 Washer
24 a Through hole
25 Holding part
25 a Through hole
26 Pre-assembly assembly
27 locking arms
28 Headboard
29 recesses, compensating element

1. A high-current connection system for a high-current-conducting connection of at least two high-current busbars that are spaced apart from one another, comprising:
a high-current-conducting bridging part which is able to be fastened to each of the high-current busbars and by which a distance between the high-current busbars of the same is able to be current-conductively bridged and with which at least two spaced-apart, spherically inwardly domed connection faces are associated;
for each high-current busbar, a high-current-conducting compensation element which is able to be associated with said high-current busbar, and which is able to be disposed between the bridging part and the associated high-current busbar, and which has a spherically outwardly domed compensation face which, when the bridging part is in a fastened state, faces one of the spherically inwardly domed connection faces and is electrically conductively connected thereto; and
for each high-current busbar, at least one fastening element which is able to be associated with the high-current busbar and by which the bridging part and the associated compensation element are able to be fastened to the associated high-current busbar and secured against movement relative to the associated high-current busbar;
wherein the bridging part is formed in a wave-shaped manner in a longitudinal section; and
in the fastened state of the bridging part, at least one of a wave trough of the bridging part is arranged between the high-current busbars or each of the connection faces associated with the bridging part is arranged in each case in a region of a wave crest of the bridging part.

2. The high-current connection system according to claim 1, further comprising a detachable connection of the at least two high-current busbars spaced apart from one another, wherein for each high-current busbar the at least one fastening element is developed in such a way that the bridging part and the associated compensation element are able to be detachably fastened to the associated high-current busbar and are able to be secured against movement relative to the associated high-current busbar.

3. The high-current connection system according to claim 1, wherein each compensation element has an associated central through-hole through which one of the fastening elements engages in the fastened state of the bridging part.

4. The high-current connection system according to claim 1, wherein the bridging part has at least two through-holes, wherein each of the through-holes has the at least one fastening element engaging therethrough it in the fastened state of the bridging part.

5. The high-current connection system according to claim 1, wherein, in the fastened state of the bridging part, each through-hole of the bridging part is aligned with a through-hole of one of the compensation elements along a common axis, one above the other, and in that the at least one fastening element in the fastened state engages through the through-hole of the bridging part and the through-hole of the compensation element.

6. The high-current connection system according to claim 1, wherein, in the fastened state of the bridging part, the at least one fastening element enters into a through-hole of the associated high-current busbar or engages through the through-hole and is connected in a force-fitting or form-fitting manner to a matching securing part of the high-current connection system, the matching securing part being supported on the high-current busbar.

7. The high-current connection system according to claim 6, wherein the at least one fastening element is a screw which, in the fastened state of the bridging part, enters into a through-hole of the associated high-current busbar or engages through the through-hole and is screwed in a force-fitting and/or form-fitting manner to a matching securing part of the high-current connection system, the matching securing part being supported on the high-current busbar and having a matching thread.

8. The high-current connection system according to claim 1, wherein each compensation element has, on a side located opposite the compensation face, a flat side which, in the fastened state of the bridging part, faces the associated high-current busbar.

9. The high-current connection system according to claim 1, wherein the high-current busbars, in the fastened state of the bridging part, are connected to one another in a high-current-conducting manner via the electrically conductive bridging part and the associated electrically conductive compensation element, so that electric current is able to flow through these components from the one high-current busbar to the other high-current busbar.

10. The high-current connection system according to claim 1, wherein, in the fastened state of the bridging part, a head part of each fastening element for securing the bridging part against relative movements relative to the associated high-current busbar bears in a force-fitting or form-fitted manner under tension directly on the bridging part or on an associated washer arranged between the associated head part and the bridging part.

11. The high-current connection system according to claim 1, wherein the high-current connection system has, for each compensation element, a retaining part which can be fastened in a force-fitting or form-fitted manner therein, by which the associated compensation element is able to be fastened in a detachable manner on the bridging part with its outer side facing the associated connection face of the bridging part.

12. The high-current connection system according to claim 11, wherein the retaining part has at least one locking means for fastening to the associated compensation element, wherein the locking means comprises at least one elastic locking arm which in the fastened state engages in a fastening recess of the compensation element.

13. The high-current connection system according to claim 11, wherein the retaining part has a through-hole into which the head part of the associated fastening element is at least partially inserted in the fastened state of the bridging part.

14. The high-current connection system according to claim 1, wherein each washer has, on its side facing the bridging part, a spherically inwardly domed compensation face which faces a spherically outwardly domed connection face of the bridging part.

15. The bridging part for the high-current connection system according to claim 1, wherein the bridging part is designed to be a high-current-conducting part, is able to be fastened to each of the high-current busbars, is designed to bridge the distance between the high-current busbars in a current-conducting manner, and has the at least two spaced, spherically inwardly domed connection faces, and the bridging part is formed in the wave-shaped manner in the longitudinal section, and in the fastened state of the bridging part, at least one of the wave trough of the bridging part is arranged between the high-current busbars, or each of the connection faces associated with the bridging part is arranged in each case in the region of the wave crest of the bridging part.

16. An arrangement comprising the at least two high-current busbars and the high-current connection system according to claim 1, wherein the two high-current busbars are connected to the high-current connection system in a high-current-conducting manner with one another.
